(19) United States
(12) Patent Application Publication
(10) Pub. No.: US 2025/0131527 A1
(43) Pub. Date: Apr. 24, 2025

(54) IMAGING ELEMENT, IMAGING DEVICE, AND IMAGING METHOD

(71) Applicant: Sony Semiconductor Solutions Corporation, Kanagawa (JP)

(72) Inventors: Katsuya Yachi, Kanagawa (JP); Yasuhiro Kaneo, Fukuoka (JP)

(21) Appl. No.: 18/682,725

(22) PCT Filed: Sep. 6, 2022
(86) PCT No.: PCT/JP2022/033396

§ 371 Date: Feb. 9, 2024

(30) Foreign Application Priority Data
Oct. 1, 2021 (JP) 2021-162676

(51) Int. Cl. G06T 3/40; H04N 25/46

(52) U.S. Cl. CPC G06T 3/40; H04N 25/46

(57) ABSTRACT

An imaging element (10) according to an aspect of the present disclosure includes a pixel unit (11) including a plurality of pixels, a generation processing unit (23) that generates, from a first image (for example, a capture image (G1)) having first resolution obtained by the pixel unit (11), a second image (for example, a preview image (G2)) having second resolution lower than the first resolution, and an output processing unit (24) that identifiably 10 outputs the first image and the second image (for example, the captured image (G1) and the preview image (G2)).

### FIELD

The present disclosure relates to an imaging element, an imaging device, and an imaging method.

### BACKGROUND

Normally, in an imaging device, an image output from an imaging element is recorded in a memory and a preview image is generated from the recorded image and displayed. Therefore, the imaging device needs a resource for creating a preview image from the recorded image with an application processor or the like (see, for example, Patent Literature 1.).

### CITATION LIST

### Patent Literature

Patent Literature 1: JP 2013-207432 A

### SUMMARY

### Technical Problem

However, for example, when a high-definition large-capacity image is recorded or when a large number of images are continuously recorded, in some case resources are taken for recording processing, a preview image is not generated in real time, and the preview image is interrupted. For example, when a zoom image and a preview image are generated and displayed, depending on an image size, in some case, an image is not generated in real time and a display image is interrupted. For these reasons, it is desired to suppress a processing load of processing image data at an output destination of the image data.

Therefore, the present disclosure proposes an imaging element, an imaging device, and an imaging method capable of suppressing a processing load of processing image data at an output destination of the image data.

### Solution to Problem

An imaging element according to the embodiment of the present disclosure includes: a pixel unit including a plurality of pixels; a generation processing unit that generates, from a first image having first resolution obtained by the pixel unit, a second image having second resolution lower than the first resolution; and an output processing unit that identifiably outputs the first image and the second image.

An imaging element according to the embodiment of the present disclosure includes: a pixel unit including a plurality of pixels; a generation processing unit that generates, from a first image having first resolution obtained by the pixel unit, a second image having second resolution lower than the first resolution; a crop processing unit that cuts out a third image from the first image; and an output processing unit that identifiably outputs the second image and the third image.

### BRIEF DESCRIPTION OF DRAWINGS

FIG. 1 is a diagram illustrating an example of a schematic configuration of an imaging element according to a first embodiment.

FIG. 2 is a diagram illustrating an example of a schematic configuration of a signal processing unit according to the first embodiment.

FIG. 3 is a diagram illustrating an example of a timing chart according to the first embodiment.

FIG. 4 is a diagram illustrating an example of a schematic configuration of a signal processing unit according to a second embodiment.

FIG. 5 is a diagram illustrating an example of a schematic configuration of a signal processing unit according to a third embodiment.

FIG. 6 is a diagram illustrating an example of a schematic configuration of a signal processing unit according to a fourth embodiment.

FIG. 7 is a diagram illustrating an example of a timing chart according to the fourth embodiment.

FIG. 8 is a diagram illustrating an example of a schematic configuration of a signal processing unit according to a fifth embodiment.

FIG. 9 is a diagram illustrating an example of a schematic configuration of a pixel unit.

FIG. 10 is a diagram illustrating an application example in which an imaging element is used.

FIG. 11 is a diagram illustrating an example of a schematic configuration of an imaging device.

### DESCRIPTION OF EMBODIMENTS

Embodiments of the present disclosure are explained in detail below with reference to the drawings. Note that an element, a device, a method, and a system according to the present disclosure are not limited by the embodiments. In the embodiments explained below, basically, redundant explanation is omitted by denoting the same parts with the same reference numerals and signs.

One or a plurality of embodiments (including examples and modifications) explained below can be respectively implemented independently. On the other hand, at least a part of the plurality of embodiments explained below may be implemented in combination with at least a part of other embodiments as appropriate. These plurality of embodiments can include new characteristics different from one another. Therefore, these plurality of embodiments can contribute to solving subjects or problems different from one another and can achieve different effects.

The present disclosure is explained according to order of items described below.
1. First Embodiment
1-1. Configuration example of an imaging element
1-2. Configuration example of a signal processing unit
1-3. Example of a timing chart
1-4. Action and effects
2. Second Embodiment
2-1. Configuration example of a signal processing unit
2-2. Action and effects
3. Third Embodiment
3-1. Configuration example of a signal processing unit
3-2. Action and effects
4. Fourth Embodiment
4-1. Configuration example of a signal processing unit
4-2. Example of a timing chart
4-3. Action and effects
5. Fifth Embodiment
5-1. Configuration example of a signal processing unit
5-2. Action and effects
6. Other Embodiments
7. Application Example
8. Notes

### 1. First Embodiment

### <1-1. Configuration Example of an Imaging Element>

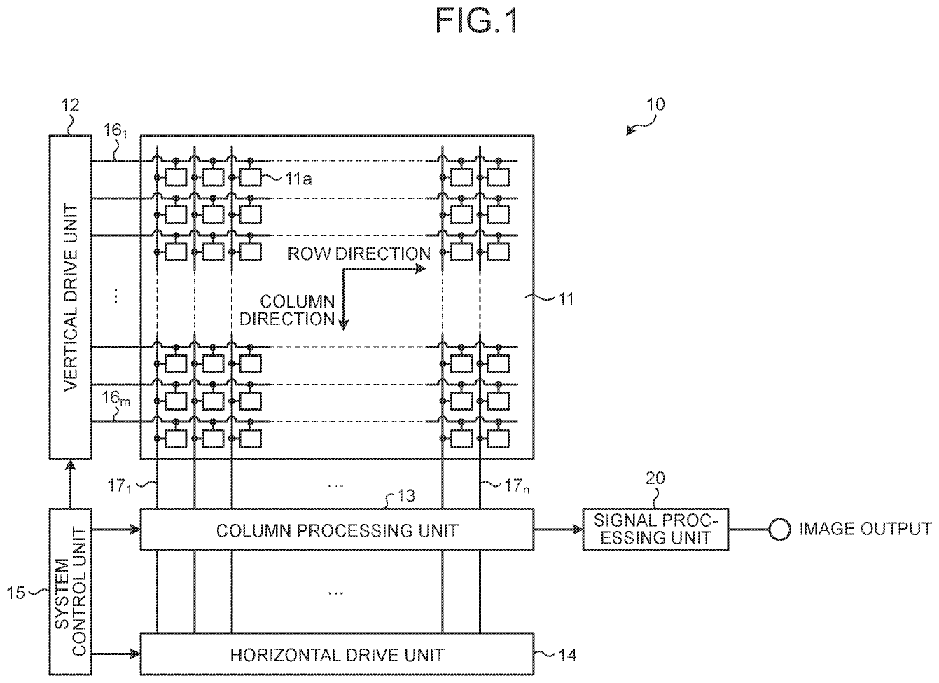

An example of a schematic configuration of an imaging element (a solid-state imaging element) 10 according to a first embodiment is explained with reference to FIG. 1. FIG. 1 is a diagram illustrating the example of the schematic configuration of the imaging element 10 according to the first embodiment.

As illustrated in FIG. 1, the imaging element 10 includes a pixel unit 11, a vertical drive unit 12, a column processing unit 13, a horizontal drive unit 14, a system control unit 15, and a signal processing unit 20. These units 11 to 15 and 20 are formed on a not-illustrated semiconductor substrate (chip). The imaging element 10 is, for example, a CMOS image sensor.

The pixel unit 11 is a pixel array unit including a plurality of pixels (unit pixels) 11a. The pixels 11a respectively generate photoelectric charges (electric charges) having a charge amount corresponding to an amount of incident light and accumulate the photoelectric charge on the insides. These pixels 11a are two-dimensionally arranged in a matrix array. The pixels 11a have a back-illuminated pixel structure including, for example, a color filter, a photoelectric conversion element, and various transistors. The pixel unit 11 includes pixel drive lines 16 (16₁ to 16ₘ) and vertical signal lines 17 (17₁ to 17ₙ). The pixel drive lines 16 (16₁ to 16ₘ) are formed in the left-right direction in FIG. 1 for each of rows with respect to a pixel array of m rows×n columns (m and n are respectively integers equal to or larger than 1). The vertical signal lines 17 (17₁ to 17ₙ) are formed in the vertical direction in FIG. 1 for each of columns with respect to the pixel array of m rows×n columns. One ends of the pixel drive lines 16 are connected to output ends corresponding to the rows of the vertical drive unit 12.

The vertical drive unit 12 is configured by, for example, a shift register and an address decoder. The vertical drive unit 12 is a pixel drive unit that drives all the pixels 11a of the pixel unit 11 at the same time or in units of rows. Pixel signals output from the pixels 11a selectively scanned by the vertical drive unit 12 are supplied to the column processing unit 13 through each of the vertical signal lines 17. For example, the vertical drive unit 12 has a configuration including a read scanning system and a sweep scanning system and can perform collective sweeping or collective transfer under driving by these scanning systems. For example, in the case of a global shutter operation, a period from the collective sweeping to the collective transfer is an accumulation period (an exposure period).

The column processing unit 13 performs, for each of the pixel rows of the pixel unit 11, predetermined signal processing on pixel signals output from the pixels 11a of a selected row through the vertical signal lines 17 and temporarily retains the pixel signals after the signal processing. Specifically, the column processing unit 13 performs at least noise removal processing, for example, CDS (Correlated Double Sampling) processing as signal processing. By the CDS by the column processing unit 13, fixed pattern noise specific to pixels such as reset noise and threshold variation of an amplification transistor is removed. Note that it is also possible to impart, for example, an AD (Analog-to-Digital) conversion function to the column processing unit 13 other than the noise removal processing and output a signal level as a digital signal.

The horizontal drive unit 14 is configured by, for example, a shift register and an address decoder. The horizontal drive unit 14 selects unit circuits corresponding to the pixel rows of the column processing unit 13 in order. By this selective scanning by the horizontal drive unit 14, pixel signals subjected to the signal processing by the column processing unit 13 are output to the signal processing unit 20 in order.

The system control unit 15 is configured by, for example, a timing generator that generates various timing signals. The system control unit 15 performs drive control for the vertical drive unit 12, the column processing unit 13, the horizontal drive unit 14, and the like based on the various timing signals generated by the timing generator.

The signal processing unit 20 outputs an image based on the pixel signal. The signal processing unit 20 is capable of performing various kinds of image processing on the image. The signal processing unit 20 functions as an image processing device that performs image processing.

### <1-2. Configuration Example of the Signal Processing Unit>

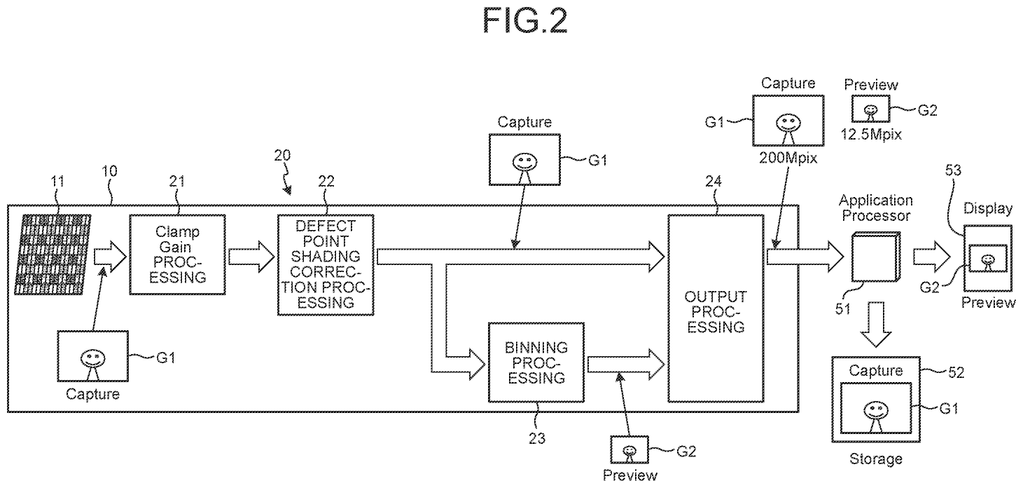

A configuration example of the signal processing unit 20 according to the first embodiment is explained with reference to FIG. 2. FIG. 2 is a diagram illustrating an example of a schematic configuration of the signal processing unit 20 according to the first embodiment.

As illustrated in FIG. 2, the signal processing unit 20 according to the first embodiment includes a preprocessing unit 21, a correction processing unit 22, a generation processing unit 23, and an output processing unit 24. Note that, in the example illustrated in FIG. 2, a device at an output destination of image data includes a processor 51, a storage medium 52, and a display unit 53. The processor 51 is, for example, an application processor.

The preprocessing unit 21 is a processing unit that performs, for example, clamp processing and gain processing on a capture image (a recording image) G1 obtained from the pixel unit 11. The clamp processing is processing for defining a black level. The gain processing is processing for amplifying a pixel value. Note that the preprocessing unit 21 may execute various kinds of processing other than the clamp processing and the gain processing. The capture image G1 is equivalent to the first image.

The correction processing unit 22 is a processing

unit that performs, for example, defect point correction processing and shading correction processing on the capture image G1 processed by the preprocessing unit 21. The defect point correction processing is processing of complementing a defective pixel. The shading correction processing is processing for correcting of brightness and darkness unevenness, aberration, and the like.

The generation processing unit 23 is a processing unit that performs, for example, binning processing on the capture image G1 processed by the correction processing unit 22 to generate a preview image G2 having resolution lower than the resolution of the capture image G1. The binning processing is processing for combining a plurality of pixels 11a adjacent to one another and reducing resolution to generate a high-sensitivity image. In the example illustrated in FIG. 2, the resolution of the capture image G1 is 200 Mpix, the resolution of the preview image G2 is 12.5 (=200/16) Mpix, and an angle of view of the capture image G1 and an angle of view of the preview image G2 are the same. Note that the generation processing unit 23 may execute various kinds of processing other than the binning processing. The preview image G2 is equivalent to a second image.

The output processing unit 24 is a processing unit that identifiably outputs the capture image G1 processed by the correction processing unit 22 and the preview image G2 generated by the generation processing unit 23. For example, the output processing unit 24 alternately outputs the capture image G1 and the preview image G2 in the same frame and with identifiers added to the capture image G1 and the preview image G2 for each of lines.

The processor 51 records the capture image G1 output from the output processing unit 24 in the storage medium 52 and displays the preview image G2 output from the output processing unit 24 on the display unit 53. At this time, the processor 51 identifies the capture image G1 and the preview image G2 based on the identifiers for each of the capture image G1 and the preview image G2 and executes the recording processing or the display processing according to a result of the identification.

According to such processing, the capture image G1 and the preview image G2 are processed in parallel by the signal processing unit 20 of the imaging element 10 and are alternately output in units of lines with separate identifiers added to the capture image G1 and the preview image G2. Consequently, it is possible to suppress a processing load of processing the image data in the device at the output destination of the image data. The processor 51 of the device at the output destination can simultaneously record the real-time capture image G1 and display the preview image G2. For example, in the device at the output destination of the image data, the processor 51 does not need a resource for creating the preview image G2 from the capture image G1 and is capable of allocating resources to recording of a large-capacity capture image G1 and processing for correcting the capture image G1. Therefore, it is possible to simultaneously realize recording of the capture image G1 and display of the preview image G2 in real time and it is possible to eliminate a darkening time during the preview.

Here, the functional units such as the preprocessing unit 21, the correction processing unit 22, the generation processing unit 23, and the output processing unit 24 explained above may be configured by both or one of hardware and software. Configurations of the units are not particularly limited. For example, the functional units may be implemented by an integrated circuit such as an ASIC (Application Specific Integrated Circuit) or an FPGA (Field-Programmable Gate Array). The functional units may be implemented by a program stored in advance in a ROM being executed by a computer such as a CPU or an MPU using a RAM or the like as a work area.

### <1-3. Example of a Timing Chart>

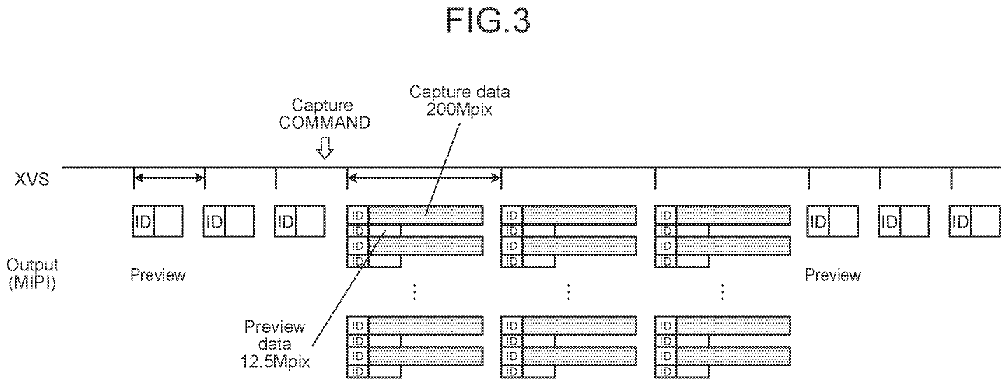

An example of a timing chart according to the first embodiment is explained with reference to FIG. 3. FIG. 3 is a diagram illustrating the example of the timing chart according to the first embodiment.

As illustrated in FIG. 3, the preview image G2 is sequentially output by the output processing unit 24. In a state in which the preview image G2 is being output, a capture command is input. The capture command is input, for example, by an input unit (for example, a button or a touch panel) included in a device at an output destination of image data being operated by a user. When the capture command is input, the capture image G1 is output by the output processing unit 24 in addition to the preview image G2. At this time, the capture image G1 and the preview image G2 are alternately output in the same frame with identifiers (for example, IDs) added to the capture image G1 and the preview image G2 for each of lines.

Consequently, it is possible to simultaneously output the large-capacity capture image G1 and the preview image G2 in real time.

In the example illustrated in FIG. 3, the resolution of the capture image G1 is 200 Mpix and the resolution of the preview image G2 is 12.5 (=200/16) Mpix. The preview image G2 is an image in which 4×4 pix of the capture image G1 is set as 1 pix. In this case, the output is executed such that one line of the preview image G2 is mixed in four lines of the capture image G1.

Note that the capture image G1 and the preview image G2 are alternately output in the same frame and with identifiers added for each of the lines but are not limited to this. For example, the capture image G1 and the preview image G2 may be alternately output with identifiers added to the capture image G1 and the preview image G2 for each of blocks or may not be alternately output. For example, a memory may be provided in the output processing unit 24, one of the capture image G1 and the preview image G2 may be temporarily stored in the memory, and the other may be output and then one may be output. However, in this case, a memory is required and recording processing in the memory is also required. Therefore, in order to simplify a configuration and improve processing speed, it is desirable to alternately output the capture image G1 and the preview image G2.

### <1-4. Action and Effects>

As explained above, according to the first embodiment, the imaging element 10 includes the pixel unit 11 including the plurality of pixels 11a, the generation processing unit 23 that generates, from the first image (for example, the capture image G1) having first resolution obtained by the pixel unit 11, the second image (for example, the preview image G2) having second resolution lower than the first resolution, and the output processing unit 24 that identifiably outputs the first image and the second image. Consequently, at an output destination of image data, it is possible to identify the first image and the second image, record the first image, and display the second image. Therefore, at the output destination of the image data, processing of generating the second image from the first image is unnecessary and a processing load of processing the image data can be suppressed.

The output processing unit 24 may output the first image and the second image in the same frame. Consequently, the processing load of processing the image data at the output destination of the image data can be reliably suppressed.

The output processing unit 24 may alternately output the first image and the second image with identifiers added to the first image and the second image for each line. Consequently, it is possible to reliably identify the first image and the second image, record the first image, and display the second image at the output destination of the image data. Therefore, it is possible to reliably suppress the processing load of processing the image data.

The generation processing unit 23 may execute binning processing on the first image to generate the second image. Consequently, the second image having the second resolution lower than the first resolution can be easily generated.

An angle of view of the first image and an angle of view of the second image may be the same. Consequently, the first image and the second image having the same angle of view can be output.

### 2. Second Embodiment

### <2-1. Configuration Example of a Signal Processing Unit>

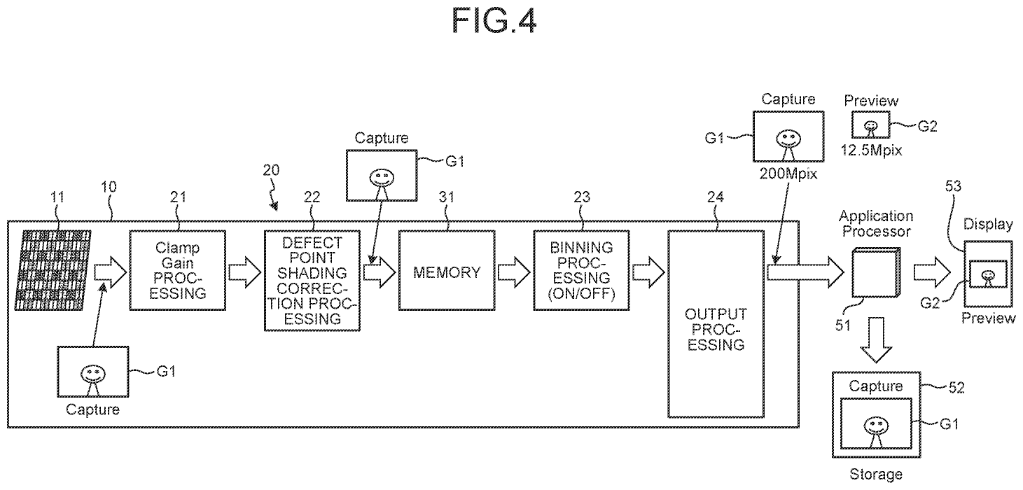

A configuration example of the signal processing unit 20 according to the second embodiment is explained with reference to FIG. 4. FIG. 4 is a diagram illustrating an example of a schematic configuration of the signal processing unit 20 according to the second embodiment.

As illustrated in FIG. 4, the signal processing unit 20 according to the second embodiment includes a storage unit (a memory) 31 in addition to the units 21 to 24 according to the first embodiment. The storage unit 31 stores the capture image G1 processed by the correction processing unit 22.

The generation processing unit 23 switches implementation or non-implementation of the binning processing for the capture image G1 stored by the storage unit 31 (ON/OFF of the binning processing) to generate the preview image G2 and sends the preview image G2 to the output processing unit 24, and sends the capture image G1 stored by the storage unit 31 to the output processing unit 24 as it is. For example, the generation processing unit 23 alternately sends the capture image G1 and the preview image G2 to the output processing unit 24 for each of lines in the same frame. In response to this, the output processing unit 24 alternately outputs the capture image G1 and the preview image G2 sent from the generation processing unit 23 with identifiers added to the capture image G1 and the preview image G2 for each of the lines.

According to such processing, the capture image G1 and the preview image G2 are obtained by the signal processing unit 20 of the imaging element 10 and are alternately output in units of lines with individual identifiers added to the capture image G1 and the preview image G2. Consequently, it is possible to suppress a processing load of processing the image data in the device at the output destination of the image data. The processor 51 of the device at the output destination can simultaneously record the real-time capture image G1 and display the preview image G2.

### <2-2. Action and Effects>

As explained above, according to the second embodiment, effects can be obtained as in the first embodiment. That is, according to the second embodiment, the imaging element 10 further includes the storage unit 31 that stores the first image (for example, the capture image G1), and the generation processing unit 23 generates the second image (for example, the preview image G2) from the first image stored by the storage unit 31 and sends the second image to the output processing unit 24, and sends the first image stored by the storage unit 31 to the output processing unit 24 as it is. With such a configuration as well, the processing load of processing the image data at the output destination of the image data can be suppressed.

### 3. Third Embodiment

### <3-1. Configuration Example of a Signal Processing Unit>

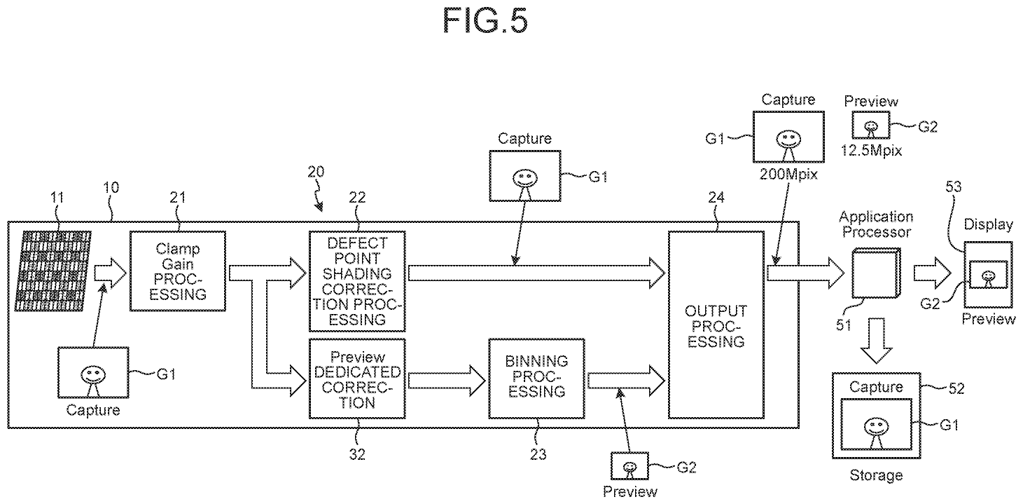

A configuration example of the signal processing unit 20 according to a third embodiment is explained with reference to FIG. 5. FIG. 5 is a diagram illustrating an example of a schematic configuration of the signal processing unit 20 according to the third embodiment.

As illustrated in FIG. 5, the signal processing unit 20 according to the third embodiment includes a correction processing unit 32 in addition to the units 21 to 24 according to the first embodiment. Note that the correction processing unit 22 is equivalent to the first correction processing unit and the correction processing unit 32 is equivalent to the second correction processing unit. In the example illustrated in FIG. 5, a branch point of signal processing according to the second embodiment is different from a branch point of the signal processing according to the first embodiment. Note that the branch point of the signal processing may be another position different from the branch points illustrated in FIG. 5 and FIG. 3.

The correction processing unit 32 is a processing unit that performs, for example, defect point correction processing on the capture image G1 processed by the preprocessing unit 21. The correction processing unit 32 performs dedicated correction processing for generating the preview image G2. Note that a correction degree of the correction processing unit 32 may be lower than a correction degree of the correction processing unit 22. In this case, a processing load relating to the correction processing can be suppressed.

According to such processing, the capture image G1 and the preview image G2 are processed in parallel by the signal processing unit 20 of the imaging element 10 and are alternately output in units of lines with individual identifiers added to the capture image G1 and the preview image G2. Consequently, it is possible to suppress a processing load of processing the image data in the device at the output destination of the image data. The processor 51 of the device at the output destination can simultaneously record the real-time capture image G1 and display the preview image G2.

### <3-2. Action and Effects>

As explained above, according to the third embodiment, effects can be obtained as in the first embodiment. That is, according to the third embodiment, the imaging element 10 includes the first correction processing unit (for example, the correction processing unit 22) that corrects the first image (for example, the capture image G1) and the second correction processing unit (for example, the correction processing unit 32) that corrects the first image as an image to be used for generating the second image (for example, the preview image G2). The generation processing unit 23 generates the second image from the first image corrected by the second correction processing unit. The output processing unit 24 identifiably outputs the first image corrected by the first correction processing unit and the second image generated by the generation processing unit 23. With such a configuration as well, the processing load of processing the image data at the output destination of the image data can be suppressed.

A correction degree of the second correction processing unit may be lower than a correction degree of the first correction processing unit. Consequently, a processing load relating to the correction processing can be suppressed.

### 4. Fourth Embodiment

### <4-1. Configuration Example of a Signal Processing Unit>

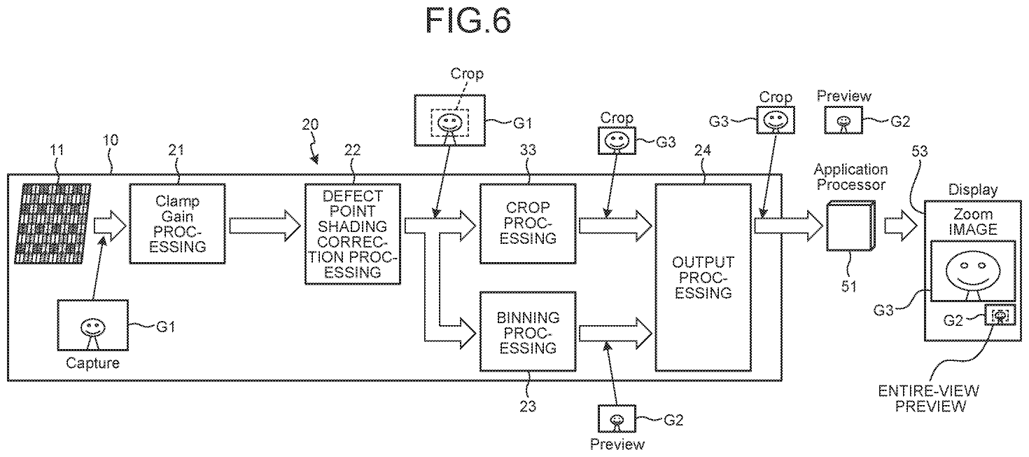

A configuration example of the signal processing unit 20 according to a fourth embodiment is explained with reference to FIG. 6. FIG. 6 is a diagram illustrating an example of a schematic configuration of the signal processing unit 20 according to the fourth embodiment.

As illustrated in FIG. 6, the signal processing unit 20 according to the fourth embodiment includes a crop processing unit 33 in addition to the units 21 to 24 according to the first embodiment. The crop processing unit 33 is a processing unit that performs crop processing on the capture image G1 processed by the correction processing unit 22. The crop processing is processing of cutting out a crop image (a zoom image) G3 from the capture image G1. The crop processing is executed in parallel to binning processing. A crop image G3 is a part of the capture image G1. An angle of view of the crop image G3 is different from an angle of view of the preview image G2. The crop image G3 is equivalent to the third image.

The output processing unit 24 is a processing unit that identifiably outputs the crop image G3 processed by the crop processing unit 33 and the preview image G2 generated by the generation processing unit 23. For example, the output processing unit 24 alternately outputs the crop image G3 and the preview image G2 in the same frame and with identifier added to the crop image G3 and the preview image G2 for each of lines.

The processor 51 displays the crop image G3 and the preview image G2 output from the output processing unit 24 on the display unit 53. At this time, the processor 51 identifies the crop image G3 and the preview image G2 based on the identifiers for each of the crop image G3 and the preview image G2 and executes display processing according to a result of the identification.

In the example illustrated in FIG. 6, the crop image G3 is displayed larger than the preview image G2. In a device at an output destination of image data, it is possible to simultaneously display, on the display unit 53, the crop image G3 obtained by cutting out a high-definition image and the preview image G2 of an entire view, data of which is reduced for preview by the binning processing.

Note that a crop position may be manually changed from the preview image G2 of the entire view and a person or an object may be discriminated on the device side at the output destination and automatically adjusted to a position corresponding to a result of the discrimination.

### <4-2. Example of a Timing Chart>

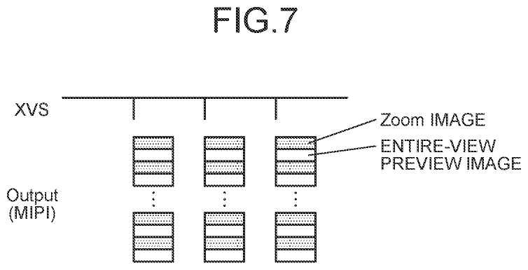

An example of a timing chart according to the fourth embodiment is explained with reference to FIG. 7. FIG. 7 is a diagram illustrating the example of the timing chart according to the fourth embodiment.

As illustrated in FIG. 7, the crop image (the zoom image) G3 and the preview image G2 of the entire view are output by the output processing unit 24. At this time, the crop image G3 and the preview image G2 of the entire view are alternately output in the same frame and with identifiers added to the crop image G3 and the preview image G2 for each of lines. Consequently, the crop image G3 and the preview image G2 can be simultaneously output in real time.

Here, for example, when the capture image G1 is directly output as a large-scale image and the processor 51 creates the crop image G3 and the preview image G2 of the entire view on the output destination side of the image data, processing cannot catch up with real time depending on an image size. Therefore, as explained above, by obtaining the crop image G3 and the preview image G2 of the entire view on the imaging element 10 side, the crop image G3 and the preview image G2 of the entire view can be displayed on the display unit 53 in real time on the output destination side of the image data without being processed. Since processing data to be output is optimized at an output stage for the display unit 53, it is possible to realize low power on the output destination side of the image data.

### <4-3. Action and Effects>

As explained above, according to the fourth embodiment, effects can be obtained as in the first embodiment. That is, according to the fourth embodiment, the imaging element 10 includes the pixel unit 11 including the plurality of pixels 11a, the generation processing unit 23 that generates, from the first image (for example, the capture image G1) having the first resolution obtained by the pixel unit 11, the second image (for example, the preview image G2) having the second resolution lower than the first resolution, the crop processing unit 33 that cuts out the third image (for example, the crop image G3) from the first image, and the output processing unit 24 that identifiably outputs the second image and the third image. Consequently, at the output destination of the image data, it is possible to identify and display the second image and the third image. Therefore, at the output destination of the image data, processing for generating the second image and the third image from the first image is unnecessary. A processing load of processing the image data can be suppressed.

The output processing unit 24 may output the second image and the third image in the same frame. Consequently, the processing load of processing the image data at the output destination of the image data can be reliably suppressed.

The output processing unit 24 may alternately output the second image and the third image with identifiers added to the second image and the third image for each of lines. Consequently, at the output destination of the image data, it is possible to reliably identify the second image and the third image and display the second image and the third image. Therefore, the processing load of processing the image data can be reliably suppressed.

### 5. Fifth Embodiment

### <5-1. Configuration Example of a Signal Processing Unit>

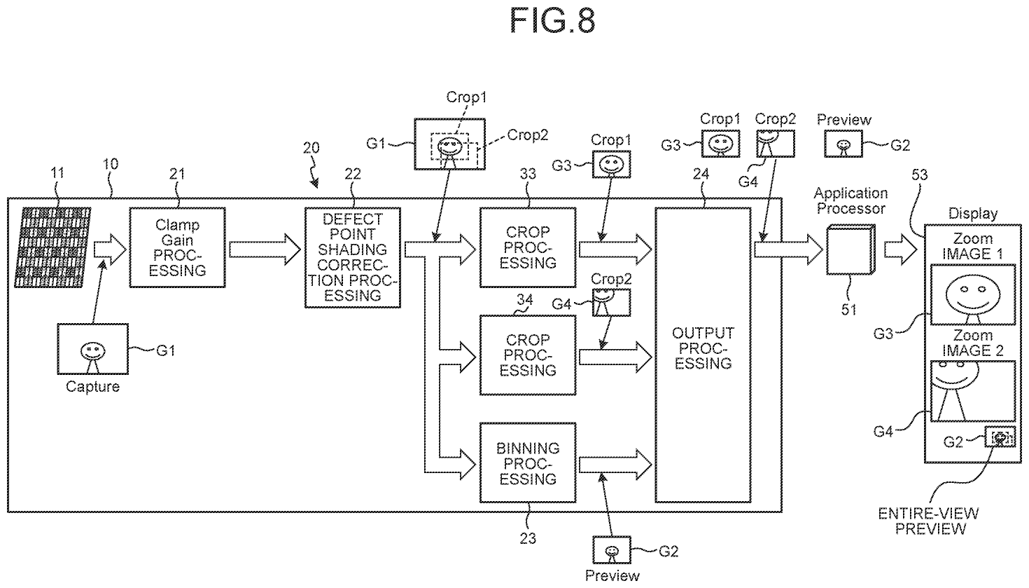

A configuration example of the signal processing unit 20 according to a fifth embodiment is explained with reference to FIG. 8. FIG. 8 is a diagram illustrating an example of a schematic configuration of the signal processing unit 20 according to the fifth embodiment.

As illustrated in FIG. 8, the signal processing unit 20 according to the fifth embodiment includes a crop processing unit 34 in addition to the units 21 to 24 and 33 according to the fourth embodiment. The crop processing unit 34 has the same configuration as the configuration in the fourth embodiment. In the example illustrated in FIG. 8, two crop processing units 33 and 34 are provided. However, the number of crop processing units is not limited and may be three or more. Each crop processing is executed in parallel to binning processing. Consequently, a plurality of crop images G3 and G4 are displayed by the display unit 53 together with the preview image G2 of an entire view. The crop images G3 are respectively equivalent to the third image.

According to such processing, the plurality of crop images G3 and G4 and the preview image G2 of the entire view are processed in parallel by the signal processing unit 20 of the imaging element 10 and the crop images G3 and G4 and the preview image G2 are output in order in units of line with individual identifiers respectively added to the crop images G3 and G4 and the preview image G2. Consequently, it is possible to suppress a processing load of processing image data in a device at an output destination of image data. Real-time display of the crop images G3 and G4 and display of the preview image G2 of the entire view can be simultaneously performed by the processor 51 of the device at the output destination.

### <5-2. Action and Effects>

As explained above, according to the fifth embodiment, effects can be obtained as in the first embodiment. That is, according to the fifth embodiment, the imaging element 10 includes the plurality of crop processing units 33 and 34 that respectively cut out the third image (for example, the crop images G3 and G4) from the first image (for example, the capture image G1). The output processing unit 24 identifiably outputs the plurality of third images respectively cut out by the crop processing units 33 and 34 and the second image (for example, the preview image G2 of the entire view) generated by the generation processing unit 23. With such a configuration as well, the processing load of processing the image data at the output destination of the image data can be suppressed.

The output processing unit 24 may output a plurality of third images and a second image in the same frame. Consequently, the processing load of processing the image data at the output destination of the image data can be reliably suppressed.

The output processing unit 24 may output the plurality of third images and the second image in order (alternatively) with identifiers added to the third images and the second images for each of lines. Consequently, it is possible to reliably identify the third images and the second images and display the third images and the second images at the output destination of the image data. Therefore, it is possible to reliably suppress the processing load of processing the image data.

### 6. Other Embodiments

The processing according to the embodiments (or modifications) explained above may be implemented in various different modes (modifications) other than the embodiments explained above. For example, among the kinds of processing explained in the embodiments, all or a part of the kinds of processing explained as being automatically performed can be manually performed or all or a part of the kinds of processing explained as being manually performed can be automatically performed by a known method. Besides, the processing procedures, the specific names, and the information including the various data and parameters explained in the document and illustrated in the drawings can be optionally changed except when specifically noted otherwise. For example, the various kinds of information illustrated in the figures are not limited to the illustrated information.

The illustrated components of the devices are functionally conceptual and are not always required to be physically configured as illustrated in the figures. That is, specific forms of distribution and integration of the devices are not limited to the illustrated forms and all or a part thereof can be configured by being functionally or physically distributed and integrated in any unit according to various loads, usage situations, and the like.

The embodiments (or modifications) explained above can be combined as appropriate in a range in which processing contents are not contradicted. The effects described in the present specification are merely illustrations and are not limited and other effects may be present.

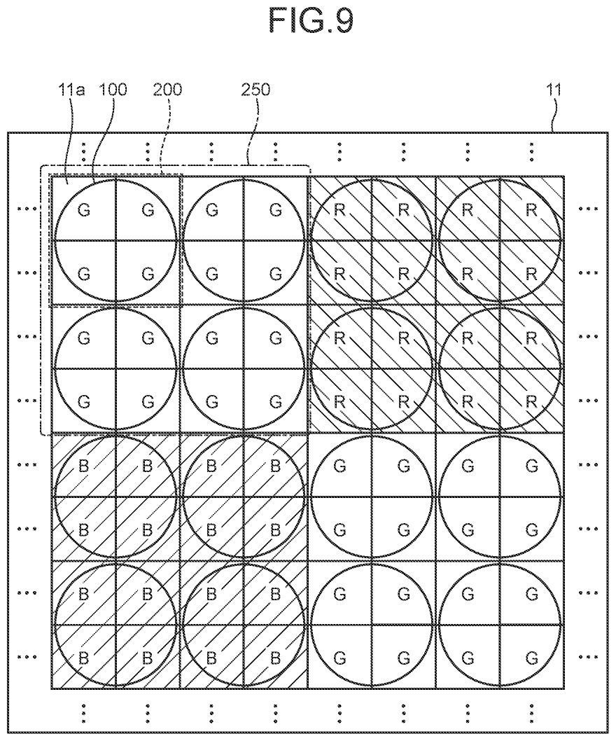

For example, color coding of the pixel unit 11 is not limited to specific color coding. As an example of the color coding of the pixel unit 11, there is color coding illustrated in FIG. 9. FIG. 9 is a diagram illustrating an example of a schematic configuration of the pixel unit 11. By using such color coding, it is possible to easily change resolution in three stages. Note that the image may be a monochrome image other than a color image. In this case, the image unit 11 may not include a color filter.

As illustrated in FIG. 9, the pixels 11a are arrayed in the pixel unit (the pixel array unit) 11. The figure illustrates an example in which the pixels 11a are array in a two-dimensional matrix. Note that “R”, “G”, and “B” added to the pixels 11a in the figure represent types of color filters explained below. “R”, “G”, and “B” in the figure respectively represent disposition of the color filters corresponding to red light, green light, and blue light. Outlined rectangles in the figure represent the pixels 11a in which color filters corresponding to green light are disposed. Rectangles hatched downward to the right in the figure represent the pixels 11a in which color filters corresponding to red light are disposed. Rectangles hatched upward to the right in the figure represent the pixels 11a in which color filters corresponding to blue light are disposed.

On-chip lenses 100 are disposed in the pixels 11a. The on-chip lenses 100 condense incident light on photoelectric conversion units (for example, photoelectric conversion elements) of the pixels 11a and are disposed in common to the plurality of pixels 11a. The on-chip lenses 100 in the figure represent an example in which the on-chip lenses 100 in the figure are disposed in common to four pixels 11a arranged in two rows and two columns. The on-chip lenses 100 in the figure are disposed in common to the four pixels 11a in which color filters of the same color are disposed. The on-chip lenses 100 and the plurality of pixels 11a sharing the on-chip lenses 100 configure a pixel block 200.

A plurality of pixel blocks 200 adjacent to one another configure a pixel block unit 250. The pixel block unit 250 in the figure represents an example in which the pixel block unit 250 is configured by four pixel blocks 200 arranged in two rows and two columns. In the pixel blocks 200 included in the pixel block unit 250, color filters of the same color are disposed. The figure represents an example in which the pixel block units 250 corresponding to red light, green light, and blue light are arranged in a Bayer array. As explained above, in the imaging element 10, the plurality of pixel block units 250 are arranged in a two-dimensional matrix.

The on-chip lens 100 in the figure represents an example in which the on-chip lens 100 is configured in a circular shape in plan view. Note that the on-chip lens 100 can also be configured in a rectangular shape in plan view.

The first resolution corresponds to resolution corresponding to the density of the plurality of pixels 11a in the figure. The first resolution is the maximum resolution in the imaging element 10. The first resolution can be applied to, for example, imaging of a still image. So-called RAW data can be generated by an image signal to which the first resolution is applied. When the system control unit 15 explained above selects the first resolution, for example, an image signal addition unit included in the imaging element 10 outputs an image signal output from the imaging element 10 to the signal processing unit 20 or the like without performing addition. The second resolution corresponds to resolution

corresponding to the density of the pixel blocks 200 in the figure. As illustrated in the figure, the second resolution is ¼ resolution of the first resolution. The second resolution can be applied to, for example, imaging of a moving image equivalent to 8K. When the system control unit 15 explained above has selected the second resolution, for example, the image signal addition unit included in the imaging element 10 adds up four image signals included in the pixel block 200 and outputs an image signal after the addition to the signal processing unit 30 and the like.

Third resolution corresponds to resolution corresponding to the density of the pixel block units 250 in the figure. As illustrated in the figure, the third resolution is ¼ resolution of the second resolution and 1/16 resolution of the first resolution. The third resolution can be applied to, for example, imaging of a moving image equivalent to 4K. When an imaging control unit 40 explained above has selected the third resolution, the image signal addition unit included in the imaging element 10 adds up sixteen image signals included in the pixel block unit 250 and outputs an image signal after the addition to the signal processing unit 20 and the like.

Since the color filters of the same type are disposed in the pixels 11a included in the pixel block 200 and the pixel block unit 250, resolution can be changed by adding image signals. The resolution change processing can be simplified.

### 7. Application Example

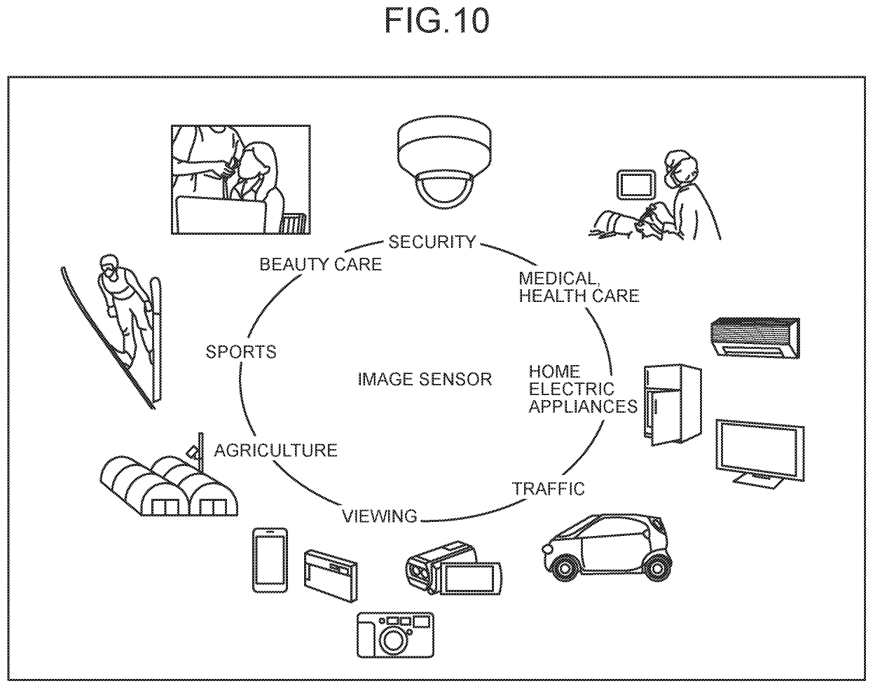

Next, an application example of the imaging element 10 according to the embodiments is explained. FIG. 10 is a diagram illustrating a use example in which the imaging element 10 according to the embodiments is used.

The imaging element 10 explained above can be used, for example, in various cases in which light such as visible light, infrared light, ultraviolet light, and an X-ray are sensed as explained below. For example, as illustrated in FIG. 10, the imaging element 10 is used for “a device that captures an image served for use of viewing such as a digital camera or a portable device with a camera function”, “a device served for use of traffic such as an in-vehicle sensor that images the front and the rear, surroundings, interior, and the like of an automobile for safe driving such as automatic stop, recognition of a driver's condition, and the like, a monitoring camera that monitors traveling vehicles and roads, and a distance measuring sensor that measures a distance between vehicles and the like”, “a device served for home electric appliances such as a TV, a refrigerator, and an air conditioner in order to capture an image of a gesture of a user and perform an equipment operation conforming to the gesture”, “a device served for use in medical care or health care such as an endoscope or a device that performs angiography by receiving infrared light”, “a device served for use in security such as a monitoring camera for crime prevention use or a camera for person authentication”, “a device served for use in beauty care such as a skin measuring instrument for imaging skin or a microscope for imaging scalp”, “a device served for use in sports such as an action camera or a wearable camera for sports use or the like”, “a device served for use in agriculture such as a camera for monitoring conditions of fields and crops”, and the like.

For example, the imaging element 10 according to the embodiments (or modifications) explained above is applied to an imaging device. The imaging device is, for example, electronic equipment such as a digital still camera, a video camera, a smartphone, a tablet terminal, a mobile phone, a PDA (Personal Digital Assistant), or a notebook PC (Personal Computer).

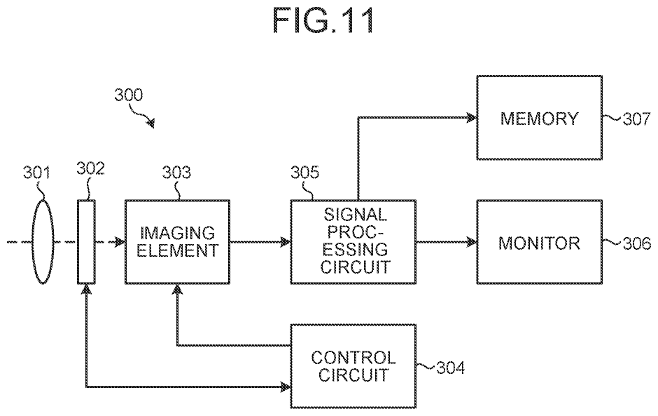

An example of an imaging device 300 is explained with reference to FIG. 11. FIG. 11 is a block diagram illustrating an example of a schematic configuration of the imaging device 300 functioning as the electronic equipment to which the present technology is applied.

As illustrated in FIG. 11, the imaging device 300 includes an optical system 301, a shutter device 302, an imaging element 303, a control circuit (a drive circuit) 304, a signal processing circuit 305, a monitor 306, and a memory 307. The imaging device 300 is capable of capturing a still image and a moving image. The imaging element 303 is any one of the imaging elements 10 according to the embodiments (or modifications) explained above. The signal processing circuit 305 is a device at an output destination of image data.

The optical system 301 includes one or a plurality of lenses. The optical system 301 guides light (incident light) from a subject to the imaging element 303 and causes the light to form an image on a light receiving surface of the imaging element 303.

The shutter device 302 is disposed between the optical system 301 and the imaging element 303. The shutter device 302 controls a light irradiation period and a light blocking period for the imaging element 303 according to control of the control circuit 304.

The imaging element 303 accumulates signal. charges for a fixed period according to the light caused to form the image on the light receiving surface via the optical system 301 and the shutter device 302. The signal charges accumulated in the imaging element 303 are transferred according to a drive signal (a timing signal) supplied from the control circuit 304.

The control circuit 304 outputs a drive signal for controlling a transfer operation of the imaging element 303 and a shutter operation of the shutter device 302 to drive the imaging element 303 and the shutter device 302.

The signal processing circuit 305 performs signal processing for recording or displaying images (for example, the capture image G1, the preview image G2, and the crop images G3 and G4) output from the imaging element 303. Image data of the preview image G2, the crop images G3 and G4, and the like is supplied to the monitor 306 and image data of the capture image G1 and the like is supplied to the memory 307. Note that the signal processing circuit 305 may perform, according to necessity, signal processing not executed by the imaging element 10.

The monitor 306 displays a moving image or a

still image captured by the imaging element 303 based on the image data supplied from the signal processing circuit 305. As the monitor 306, for example, a panel type display device such as a liquid crystal panel or an organic EL (Electro Luminescence) panel is used.

The memory 307 stores the image data supplied from the signal processing circuit 305, that is, image data of the moving image or the still image captured by the imaging element 303. As the memory 307, for example, a recording medium such as a semiconductor memory or a hard disk is used.

Similarly, in the imaging device 300 configured as explained above, by using any one of the imaging elements 10 explained above as the imaging element 303, a processing load of processing image data at an output destination of the image data can be suppressed.

Note that the technique according to the present disclosure can be applied to various products. For example, the technique according to the present disclosure may be realized as a device mounted on any type of mobile body such as an automobile, an electric vehicle, a hybrid electric vehicle, a motorcycle, a bicycle, a personal mobility, an airplane, a drone, a ship, a robot, a construction machine, or an agricultural machine (a tractor). For example, the technique according to the present disclosure may be applied to an endoscopic surgical system, a microscopic surgical system, and the like.

### 8. Notes

Note that the present technology can also take the following configurations.

(1)

An imaging element comprising:
a pixel unit including a plurality of pixels;
a generation processing unit that generates, from a first image having first resolution obtained by the pixel unit, a second image having second resolution lower than the first resolution; and
an output processing unit that identifiably outputs the first image and the second image.

(2)

The imaging element according to (1), wherein
the output processing unit outputs the first image and the second image in a same frame.

(3)

The imaging element according to (2), wherein
the output processing unit alternately outputs the first image and the second image with identifiers added to the first image and the second image for each of lines.

(4)

The imaging element according to any one of (1) to (3), wherein
the generation processing unit executes binning processing on the first image to generate the second image.

(5)

The imaging element according to any one of (1) to (4), wherein
an angle of view of the first image and an angle of view of the second image are the same.

(6)

The imaging element according to any one of (1) to (5), further comprising
a storage unit that stores the first image, wherein
the generation processing unit generates the second image from the first image stored by the storage unit and sends the second image to the output processing unit, and sends the first image stored by the storage unit to the output processing unit as it is.

(7)

The imaging element according to any one of (1) to (5), further comprising:
a first correction processing unit that corrects the first image; and
a second correction processing unit that corrects the first image as an image to be used for generating the second image,
wherein
the generation processing unit generates the second image from the first image corrected by the second correction processing unit, and
the output processing unit identifiably outputs the first image corrected by the first correction processing unit and the second image generated by the generation processing unit.

(8)

The imaging element according to (7), wherein
a correction degree of the second correction processing unit is lower than a correction degree of the first correction processing unit.

(9)

An imaging element comprising:
a pixel unit including a plurality of pixels;
a generation processing unit that generates, from a first image having first resolution obtained by the pixel unit, a second image having second resolution lower than the first resolution;
a crop processing unit that cuts out a third image from the first image; and
an output processing unit that identifiably outputs the second image and the third image.

(10)

The imaging element according to (9), wherein
the output processing unit outputs the second image and the third image in a same frame.

(11)

The imaging element according to (10), wherein
the output processing unit alternately outputs the second image and the third image with identifiers added to the second image and the third image for each of lines.

(12)

The imaging element according to (9), wherein
a plurality of the crop processing units are provided, and
the output processing unit identifiably outputs a plurality of the third images respectively cut out by the plurality of crop processing units and the second image generated by the generation processing unit.

(13)

The imaging element according to (12), wherein
the output processing unit outputs the plurality of third images and the second images in a same frame.

(14)

The imaging element according to (13), wherein
the output processing unit outputs the plurality of third images and the second image in order with identifiers added to the plurality of third images and the second image for each of lines.

(15)

The imaging element according to any one of (9) to (14), wherein
the generation processing unit executes binning processing on the first image to generate the second image.

(16)

An imaging device comprising:
an imaging element; and
an optical system that guides light to the imaging element,
wherein
the imaging element includes:
a pixel unit including a plurality of pixels;
a generation processing unit that generates, from a first image having first resolution obtained by the pixel unit, a second image having second resolution lower than the first resolution; and
an output processing unit that identifiably outputs the first image and the second image.

(17)

An imaging method comprising:
causing an imaging element, which includes a pixel unit including a plurality of pixels, to generate, from a first image having first resolution obtained by the pixel unit, a second image having second resolution lower than the first resolution; and
causing the imaging element to identifiably output the first image and the second image.

(18)

An imaging device including:
an imaging element; and
an optical system that guides light to the imaging element,
wherein
the imaging element includes:
a pixel unit including a plurality of pixels;
a generation processing unit that generates, from a first image having first resolution obtained by the pixel unit, a second image having second resolution lower than the first resolution;
a crop processing unit that cuts out a third image from the first image; and
an output processing unit that identifiably outputs the second image and the third image.

(19)

An imaging method including
causing an imaging element, which includes a pixel unit including a plurality of pixels, to generate, from a first image having first resolution obtained by the pixel unit, a second image having second resolution lower than the first resolution;
causing the imaging element to cut out a third image from the first image; and
causing the imaging element to identifiably output the second image and the third image.

(20)

An imaging device including the imaging element described in any one of (1) to (15).

(21)

An imaging method of using the imaging element described in any one of (1) to (15).

### REFERENCE SIGNS LIST

10 IMAGING ELEMENT

11 PIXEL UNIT

11a PIXEL

12 VERTICAL DRIVE UNIT

13 COLUMN PROCESSING UNIT

14 HORIZONTAL DRIVE UNIT

15 SYSTEM CONTROL UNIT

16 PIXEL DRIVE LINE

17 VERTICAL SIGNAL LINE

20 SIGNAL PROCESSING UNIT

21 PREPROCESSING UNIT

22 CORRECTION PROCESSING UNIT

23 GENERATION PROCESSING UNIT

24 OUTPUT PROCESSING UNIT

31 STORAGE UNIT

32 CORRECTION PROCESSING UNIT

33 CROP PROCESSING UNIT

34 CROP PROCESSING UNIT

51 PROCESSOR

52 STORAGE MEDIUM

53 DISPLAY UNIT

100 ON-CHIP LENS

200 PIXEL BLOCK

250 PIXEL BLOCK UNIT

300 IMAGING DEVICE

301 OPTICAL SYSTEM

302 SHUTTER DEVICE

303 IMAGING ELEMENT

304 CONTROL CIRCUIT

305 SIGNAL PROCESSING CIRCUIT

306 MONITOR

307 MEMORY

G1 CAPTURE IMAGE

G2 PREVIEW IMAGE

G3 CROP IMAGE

G4 CROP IMAGE

1. An imaging element comprising:
a pixel unit including a plurality of pixels;
a generation processing unit that generates, from a first image having first resolution obtained by the pixel unit, a second image having second resolution lower than the first resolution; and
an output processing unit that identifiably outputs the first image and the second image.

2. The imaging element according to claim 1, wherein
the output processing unit outputs the first image and the second image in a same frame.

3. The imaging element according to claim 2, wherein
the output processing unit alternately outputs the first image and the second image with identifiers added to the first image and the second image for each of lines.

4. The imaging element according to claim 1, wherein
the generation processing unit executes binning processing on the first image to generate the second image.

5. The imaging element according to claim 1, wherein
an angle of view of the first image and an angle of view of the second image are the same.

6. The imaging element according to claim 1, further comprising
a storage unit that stores the first image, wherein
the generation processing unit generates the second image from the first image stored by the storage unit and sends the second image to the output processing unit, and sends the first image stored by the storage unit to the output processing unit as it is.

7. The imaging element according to claim 1, further comprising:
a first correction processing unit that corrects the first image; and
a second correction processing unit that corrects the first image as an image to be used for generating the second image,
wherein
the generation processing unit generates the second image from the first image corrected by the second correction processing unit, and
the output processing unit identifiably outputs the first image corrected by the first correction processing unit and the second image generated by the generation processing unit.

8. The imaging element according to claim 7, wherein
a correction degree of the second correction processing unit is lower than a correction degree of the first correction processing unit.

9. An imaging element comprising:
a pixel unit including a plurality of pixels;
a generation processing unit that generates, from a first image having first resolution obtained by the pixel unit, a second image having second resolution lower than the first resolution;
a crop processing unit that cuts out a third image from the first image; and
an output processing unit that identifiably outputs the second image and the third image.

10. The imaging element according to claim 9, wherein
the output processing unit outputs the second image and the third image in a same frame.

11. The imaging element according to claim 10, wherein
the output processing unit alternately outputs the second image and the third image with identifiers added to the second image and the third image for each of lines.

12. The imaging element according to claim 9, wherein
a plurality of the crop processing units are provided, and
the output processing unit identifiably outputs a plurality of the third images respectively cut out by the plurality of crop processing units and the second image generated by the generation processing unit.

13. The imaging element according to claim 12, wherein
the output processing unit outputs the plurality of third images and the second images in a same frame.

14. The imaging element according to claim 13, wherein
the output processing unit outputs the plurality of third images and the second image in order with identifiers added to the plurality of third images and the second image for each of lines.

15. The imaging element according to claim 9, wherein
the generation processing unit executes binning processing on the first image to generate the second image.

16. An imaging device comprising:
an imaging element; and
an optical system that guides light to the imaging element,
wherein
the imaging element includes:
a pixel unit including a plurality of pixels;
a generation processing unit that generates, from a first image having first resolution obtained by the pixel unit, a second image having second resolution lower than the first resolution; and
an output processing unit that identifiably outputs the first image and the second image.

17. An imaging method comprising:
causing an imaging element, which includes a pixel unit including a plurality of pixels, to generate, from a first image having first resolution obtained by the pixel unit, a second image having second resolution lower than the first resolution; and
causing the imaging element to identifiably output the first image and the second image.
